(19) United States
(12) Patent Application Publication
(10) Pub. No.: US 2007/0117873 A1
(43) Pub. Date: May 24, 2007

(54) CARBON NANOFIBER REINFORCED THERMOPLASTIC NANOCOMPOSITE FOAMS

(75) Inventors: L. James Lee, Columbus, OH (US); Jiong Shen, Columbus, OH (US); Changchun Zeng, Salt Lake City, UT (US); Xiangmin Han, Columbus, OH (US)

Correspondence Address: STANDLEY LAW GROUP LLP, 495 METRO PLACE SOUTH, SUITE 210, DUBLIN, OH, 43017, US

(73) Assignee: THE OHIO STATE UNIVERSITY RESEARCH FOUNDATION, Columbus, OH (US)

(21) Appl. No.: 11/383,366

(22) Filed: May 15, 2006

Related U.S. Application Data
(60) Provisional application No. 60/680,989, filed on May 13, 2005.

(51) Int. Cl. C08J 9/00

(52) U.S. Cl. 521/83

(57) ABSTRACT

With extraordinary mechanical properties, carbon nanofibers (CNF) serve as reinforcements for both lightweight and ultra strong composite materials. CNF was used as the reinforcing nanoelements to synthesize polystyrene (PS)/CNF nanocomposites by the in-situ polymerization process. The obtained composites were further foamed using supercritical CO₂ as the foaming agent. A homogeneous dispersion of CNF was observed and the final PS/CNF nanocomposite foam showed microcellular foam morphology.

The present application claim priority to U.S. Provisional Application Ser. No. 60/680,989, the contents of which are hereby incorporated by reference herein.

### TECHNICAL FIELD OF THE INVENTION

The present invention is in the field of polymer foams. Specifically, the present invention relates to carbon nanofiber reinforced thermoplastic nanocomposite foams.

### BACKGROUND OF THE INVENTION

The present invention hereby incorporates by reference, application Ser. No. 10/425,565, entitled “Clay Nanocomposites Prepared by In-situ Polymerization”, filed on Apr. 29, 2002.

Polymeric foams are widely used in many applications ranging from thermal insulation to adsorbents. However, conventional foams have relatively poor mechanical properties due to the large cell size and non-uniform cell size distribution. Microcellular (MC) foams with an average cell size of less than 10 μm and a cell density of larger than 10⁹ cells/cc are of particular interest because they offer superior mechanical properties such as impact strength, toughness and fatigue life. Recently, ultramicrocellular (UMC) foams with submicron cell size have drawn increasing attention. The characteristic cell size of UMC is around 0.1 μm and the cell density falls into the range of 10⁹˜10¹² cells/cc. With the extremely small cell size, these cells do not interfere with the transmission of visible light, thus providing an obvious application for transparent insulation films. Furthermore, UMC foams with an open cell structure show great promise as bacteria filters, renal filters, and drug substrates.

Conventional methods to produce MC foams usually require stringent processing conditions such as very high pressure and pressure drop rate, which ultimately increase the processing cost. Therefore, the practical question is not whether it is possible to produce MC foams, but whether it is possible to produce MC foams that are competitive when evaluated by the “performance/cost” ratio. Previous research found that by adding nanoclay into the polymer matrix, the cell size can be greatly reduced and the cell density greatly increased, demonstrates that MC foam can be produced utilizing current foaming technology. In addition, the best dispersion of nanoclay in the polymer matrix yields the finest cell size. In the present work, a two-dimensional nano-scaled particle, carbon nanofibers (CNF), was used to synthesize polymer nanocomposites and foams.

Two important issues in forming such nanocomposites are the dispersion of CNF and the interfacial bonding between the polymer and the CNF. CNF holds together as bundles and ropes in the polymer matrix due to the intrinsic Van der Waals attraction, which impedes a homogeneous dispersion. Furthermore, good interfacial bonding between the matrix and the nanofibers is difficult to achieve because of the atomically smooth, nonreactive surface of CNF. As a result, the potential for mechanical improvements by using CNF in both nanocomposites and foams cannot be fully realized by current methods.

### SUMMARY OF THE INVENTION

The present invention includes polymeric nanocomposite foams and a method for forming polymeric nanocomposite foams.

The present invention includes a method for forming a polymeric nanocomposite comprising the steps of: (a) providing a mixture comprising: at least one monomer, an initiator, and at least one carbon fiber; and (b) processing the mixture so as to form a polymeric nanocomposite. Alternatively, the mixture may comprise: a polymer and at least one carbon fiber.

In one embodiment, the mixture additionally comprises at least one blowing agent, and the method additionally comprises the step of processing the mixture so as to cause the formation of at least one cell, thereby forming a polymeric nanocomposite foam.

A polymeric nanocomposite foam of the present invention comprises: (a) a polymeric portion; (b) at least one carbon nanofibers dispersed throughout the polymeric portion; and (c) a plurality of cells dispersed throughout the polymeric portion.

In one embodiment, the polymeric portion comprises a polymer selected from the group consisting of polystyrene, poly(methyl methacrylate), polypropylene, nylon, polyurethane, elastomers, and mixtures thereof.

In another embodiment, the polymeric nanocomposite foam additionally comprises an organophilic clay dispersed throughout the polymeric portion. X-ray diffraction patterns produced from the polymeric nanocomposite foam may or may not produce an intercalation peak.

In one embodiment, the polymeric nanocomposite foam comprises: (a) a smectite clay; and (b) a compound having the formula:

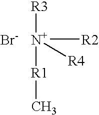

wherein: (i) R1 is (CH)ₙ wherein n ranges from 6 to 20; (ii) R2 is a chemical structure having a terminal reactive double bond; (iii) R3 is an alkyl group; and (iv) R4 is an alkyl group. It is further preferred that n is 15, R3 is CH₃, R4 is CH₃, and R2 is:

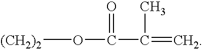

In one embodiment, the smectite clay is selected from the group consisting of montmorillonite, hectorite, saponite, laponite, florohectorite, and beidellite.

In another embodiment, the polymeric nanocomposite foam has an average cell size less than about 20 microns. In yet another embodiment, the polymeric nanocomposite foam has an average cell size greater than about 15 microns.

In one embodiment, the polymeric nanocomposite foam has an average cell density greater than about 1×10⁶ cells/cm³. In yet another embodiment, the polymeric nanocomposite foam has an average cell density greater than about 1×10⁹ cells/cm³.

The polymeric nanocomposite foams produced in accordance with the present invention may be either closed cell or open cell foams.

### BRIEF DESCRIPTION OF THE DRAWINGS

FIG. 1 is a schematic of the batch foaming set up employed in the present invention.

FIG. 2 provides SEM images of various foams (CO₂, 13.8 MPa, 120° C.): (a) PS/0.3 wt % CNF, 0.5 wt % AIBN, scale bar 20 μm; (b) PS/1 wt % CNFs, 0.5 wt % AIBN, scale bar 20 μm; (c) PS/1.5 wt % CNFs, 0.5 wt % AIBN, scale bar 20 μm; (d) PS/1 wt % CNFs, 0.75 wt % AIBN, 10% PS, scale bar 20 μm; (e) PS/0.1 wt % SWCNT, 0.75 wt % AIBN, 10% PS, scale bar 20 μm; (f) pure PS, scale bar 50 μm.

FIG. 3 provides TEM images of PS/CNFs nanocomposites wherein a dark line indicates separated CNFs and circled particles indicate CNF agglomerates: (a) PS/1 wt % CNFs, 0.5 wt % AIBN; (b) PS/1 wt % CNFs, 0.75 wt % AIBN, 10% PS.

FIG. 4 illustrates the reduction of critical nucleation energy by function, f(m,w).

FIG. 5 provides SEM images of foams (CO₂, 2000 psi, 120° C.): (a) pure PS; (b) PS/5 wt % MHABS; (c) PU#1-PS/0.3 wt % CNF; (d) PU#2-PS/1 wt % CNF; and (e) PU#3-PS/1.5 wt % CNF.

FIG. 6 provides SEM images of foams (CO₂, 2000 psi, 120° C.): (a) PU#2-1 wt % CNF, 0.5 wt % AIBN; (b) PU#4-1 wt % CNF, 0.5 wt % AIBN, 10% PS; (C) PU#5-1 wt % CNF, 0.75 wt % AIBN, 10% PS.

FIG. 7 compares the shear viscosity of two PS samples.

FIG. 8 provides SEM images of foams (CO₂, 2000 psi, 120° C.), PS/CNF composites made by melt blending process at 200° C. in a DACA micro compounder: (a) 1 wt % CNF with PS-1; and (b) 1 wt % CNF with PS-2.

FIG. 9 provides SEM images of the fracture surface of CNF/PS nanocomposites: (a) PU#1-0.3 wt % CNF; (b) PU#2-1.0 wt % CNF; (c) PU#3-1.5 wt % CNF; (d) PU#4-1.0 wt % CNF, 0.5 wt % AIBN, 10% PS; and (e) PU#5-1.0 wt % CNF, 0.75 wt % AIBN, 10% PS.

### DETAILED DESCRIPTION OF THE PREFERRED EMBODIMENT(S)

In accordance with the foregoing summary, the following presents a detailed description of the preferred embodiments of the invention that is currently considered to be the best mode.

Experimental

Materials—Vapor grown carbon nanofibers (PR-24-PS, supplied by Applied Science Inc.) were pyrolytically stripped to remove surface organic contamination. The average diameter of the CNFs was 100 nm and the original lengths ranged from 30 to 100 μm. SWCNTs (BuckyPearls™, Carbon Nanotechnologies Inc.) have an average tube diameter of 1 nm and tube length of 500 nm. Styrene and 2,2′-azobis(isobutyronitrile) (AIBN) were purchased from Aldrich and used as received.

In-situ polymerization—Due to the intrinsic van der Waals attractions, SWCNTs/CNFs are tightly entangled as bundles and ropes in their original state. Once incorporated into the polymer matrix, these attractive forces will further increase due to an entropic penalty, which is induced by the confinement of the polymer chain configuration. Therefore, the dispersion of SWCNTs/CNFs becomes a major challenge in the synthesis of polymer CNTs/CNFs composites. Strategies proposed to accomplish good dispersion include the use of ultrasonication, high shear mixing, surfactants, and fictionalization of the carbon surface. In this work, we use high-shear mixing and ultrasonication to facilitate the dispersion of CNFs and SWCNTs.

Different amounts of CNFs/SWCNTs were added to the styrene monomer, together with AIBN as the initiator. The mixtures were then homogenized for 3 minutes and sonicated for 30 minutes. Polymerization was carried out isothermally at 60° C. for 20 hours and the composites were post-cured at 105° C. for 2 hours to complete the reaction.

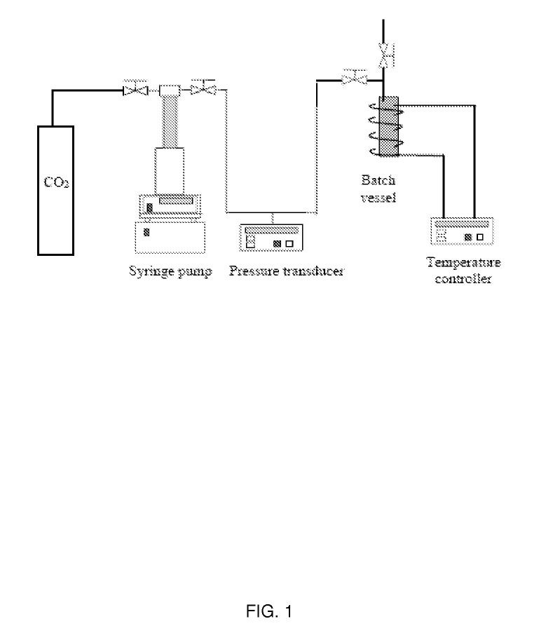

Batch foaming —PS/CNFs nanocomposites were foamed with supercritical CO₂ as the blowing agent via the batch foaming process. Samples were placed in a stainless steel vessel and CO₂ was delivered via a syringe pump. The system was allowed to equilibrate at 120° C. and 13.8 MPa for 24 hours. The pressure was rapidly released and the foam cells were fixed by cooling with a mixture of ice and water. The batch foaming set up is shown schematically in FIG. 1.

Characterization—The dispersion of nanoparticles in the polymer domain was characterized by transmission electron microscopy (TEM). Samples were microtomed at room temperature with a diamond knife and mounted on a 200-mesh copper grid. Images were obtained from a Phillips CMI2 apparatus using an accelerating voltage of 80 kV. The foam morphology was characterized by scanning electron microscopy (SEM, Philips XL30). Samples were freeze-fractured in liquid nitrogen and the fracture surface was sputter-coated with gold. The resulting micrographs were analyzed by Scion Image software to determine the cell size and cell density. Typically, a micrograph showing more than 50 bubbles is chosen. The number of bubbles (n) in this micrograph is determined by the software. If the area of the micrograph is A cm² and the magnification factor is M, the cell density (N_{f}) can be estimated as:

$${N}_{f} = {( \frac{{nM}^{ 2}}{A} )}^{\frac{3}{2}} \qquad ( 1 )$$

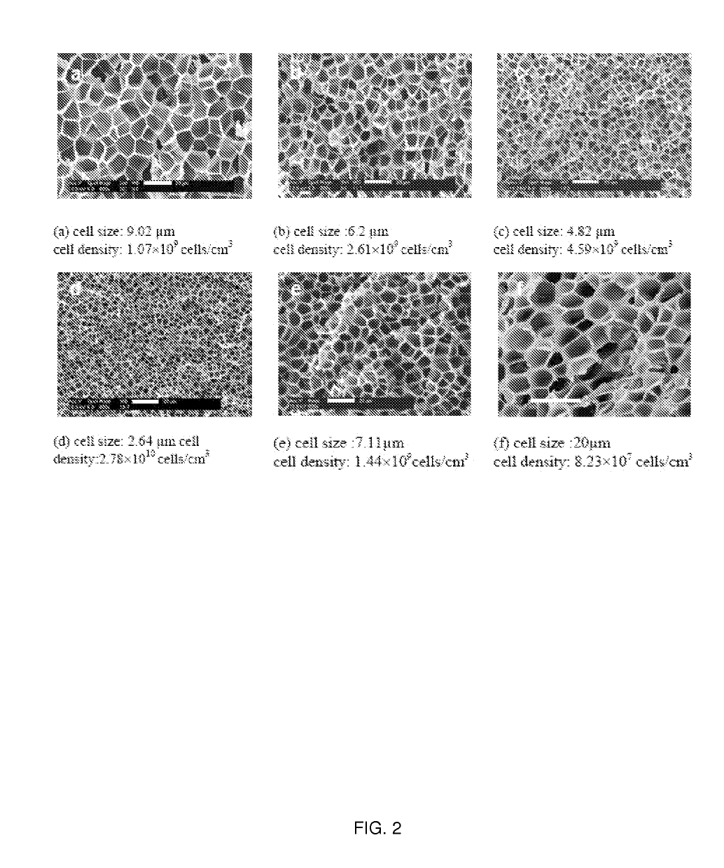

Results and Discussion PS/CNFs nanocomposite foams—A series of PS/CNFs nanocomposites with CNFs content of 0.3, 1.0, and 1.5 wt % were synthesized. These nanocomposites were subsequently foamed at 120° C. and a CO₂ pressure of 13.8 MPa. The cell morphologies are depicted in FIGS. 2a-2c. Pure PS foam (FIG. 2f) synthesized at the same foaming conditions is shown for comparison. In the presence of only 0.3 wt % CNFs, the cell density increased from 8.23×10⁷ cells/cm³ (pure PS foam) to 1.07×10⁹ cells/cm³, and the cell size decreased from 20 μm (pure PS foam) to 9.02 μm. By increasing the fiber content to 1 wt %, the cell density increased to 2.61×I0⁹ cells/cm³ and the cell size decreased to 6.2 μm. A further increase of the CNFs content to 1.5 wt % yielded foams with the cell density of 4.59×10⁹ cells/cm³ and the cell size of 4.82 μm. All PS/CNFs foams exhibit uniform cell size distribution. These results indicate that CNFs serve well as a heterogeneous nucleating agent during the foaming process. Moreover, the monotonic increase of cell density with increasing fiber content indicates that bubble nucleation is dominated by the heterogeneous mechanism with the addition of CNFs.

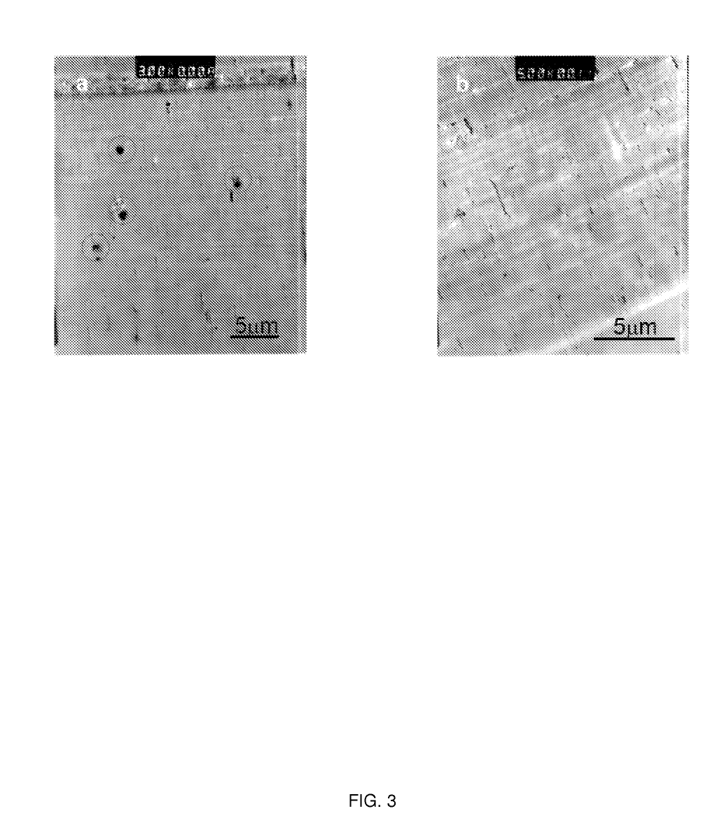

To minimize cell interactions and cell coalescence, a sparse and stable nucleant distribution is preferred. However, we noticed that in the early stage of polymerization, the system viscosity was not high enough to achieve suitable fiber separation. Thus, the CNFs were still inclined to attract each other, causing randomly distributed aggregates up to about 1 μm in the polymer matrix, as illustrated by the TEM result (FIG. 3a). Although these aggregates were observed in all the composites with fiber contents from 0.3 to 1.5 wt %, only one representative TEM image (PS/1 wt % CNFs) is shown here for illustration.

In order to improve the fiber dispersion, we added 10 wt % PS into the mixture of styrene/CNFs (1 wt %) to achieve a higher initial viscosity. An extended settling time for CNFs in a more viscous medium was observed during the experiment. By increasing the AIBN content from 0.5 to 0.75 wt %, a higher rate of viscosity increase was achieved due to the increased reaction rate. As a result, the resistance force opposed to the aggregation of fibers could be increased. The ultimate fiber dispersion in the polymer is shown in FIG. 3b. In this case, most of the fibers have been completely separated and there are no obvious fiber aggregates, indicating a noticeable improvement of fiber dispersion. The composite was subsequently batch foamed and the foam morphology is shown in FIG. 2d. Compared to its counterpart (FIG. 1b), the cell density was increased from 2.61×10⁹ cells/cm³ to 2.78×10¹⁰ cells/cm³, while the cell size decreased from 6.2 μm to 2.64 μm. Although the initiator concentration will influence the polymerization kinetics and eventually the molecular weight and polydispersity, a previous study showed that this effect is insignificant on the cell densities and cell sizes. Hence, this dramatic change of the cell structures primarily results from the improved fiber dispersion.

PS/SWCNTs nanocomposite foams —SWCNTs were used to synthesize PS nanocomposites and foams using in-situ polymerization and batch foaming processes as described previously. However, the dispersion of SWCNTs in the polymer domain is poor. From the fracture surfaces of both solid composites and foam struts, it is very difficult to observe any dispersed SWCNT. Instead, a large amount of ball-shaped aggregates with size up to a hundred nanometers form a bouquet-like pattern, which is similar to the fracture texture of the intercalated PS/nanoclay composite. The formation of this structure could be caused by the penetration of polymer chains into the gallery of nanoparticle aggregates. For this reason, nanoparticles can be completely wrapped by the polymer, forming a large amount of ball-shaped polymer/particle agglomerates. However, even with such a poor particle dispersion, the resultant PS foam with 0.1 wt % SWCNTs still displays a much higher cell density and a much smaller cell size (FIG. 2e), compared to the pure PS foam. The average cell density is 1.44×10⁹ cells/cm³ and the average cell size is 7.11 μm.

Nucleation Efficiencies of Nanoparticles—Previously, a plate-like surface-modified nanoclay (MHABS) was also used to produce PS foams under the same condition. The acrylic groups attached to the clay surfaces can react with the styrene monomer, thus enabling the direct growth of polymer chains from the clay surface. Ultimately, an exfoliated dispersion of nanoclay was achieved. The final PS nanocomposite foam with 5 wt % MHABS exhibited a cell density of 4.02×10⁸ cells/cm³ and an average cell size of 10.8 μm. However, despite an exfoliated dispersion and a higher nominal particle loading (5 wt %), the cell density of PS/MHABS foam is still lower than any of the PS/CNFs foams attained in this study.

In heterogeneous nucleation, the highest nucleation efficiency can only be achieved when the nucleation on the nucleant surface is energetically favored (relative to its homogeneous counterpart) and the nucleant is dispersed in the polymer matrix. In most cases, the observed cell density is much lower than the potential nucleant density, implying that either the nucleants are not energetically effective, or their effects have been compromised due to poor dispersion. Here we compare the nucleation efficiencies of CNFs, SWCNTs and exfoliated nanoclay with a simple analysis.

The potential nucleant density in a heterogenous nucleation system can be estimated by Eq. (2):

$$\frac{Nucleants}{{cm}^{3}} = \frac{w}{{ρ}_{P}} \frac{{ρ}_{blend}}{{V}_{P}} \qquad ( 2 )$$

where w is the weight fraction of the particle in the composite, ρ_{P} is the density of the particle, ρ_{blend} is the density of the polymer blend and V_{P} is the volume of the individual particle. In the case of CNFs, the potential nucleant density of the PS composite containing 1 wt % CNFs is 1.41×10¹²/cm³ according to Equation 2. Experimentally, the cell density of the foam with the same fiber content is 2.78×10¹⁰ cells/cm³ (shown in FIG. 2d). The proximity of these two values indicates that most of the fibers served well as nucleants in the PS foaming. The nucleation efficiency, defined by the ratio of the measured cell density to the potential nucleant density, is 1.97% for CNFs. Similar calculations were conducted for PS/MHABS and PS/SWCNTs foams and the results are listed in Table 1 below. For both clay and SWCNTs systems, the potential nucleant densities are much higher than the final cell densities, ultimately leading to nucleation efficiencies that are orders of magnitude lower than that of CNFs.

TABLE 1

| | | | Potential | | |
|---|---|---|---|---|---|
| | | | Nucleant | Measured | |
| Nano- | Wt | Dispersion | density [b] | cell density | |
| particle | % | [a] | (#/cm³) | (#/cm³) | Efficiency |
| CNF | 1 | Complete | 1.41 × 10¹² | 2.78 × 10¹⁰ | 1.97 |
| SWCNT | 0.1 | Aggregates | 1.59 × 10¹⁵ | 1.44 × 10⁹ | 9.06 × 10⁻⁵ |
| MHABS | 5 | Exfoliated | 5.45 × 10¹³ | 4.02 × 10⁸ | 7.37 × 10⁻⁴ |

[a] actual particle dispersion observed by TEM images,
[b] calculated (Eqn. 2) with the assumption of complete particle dispersion.

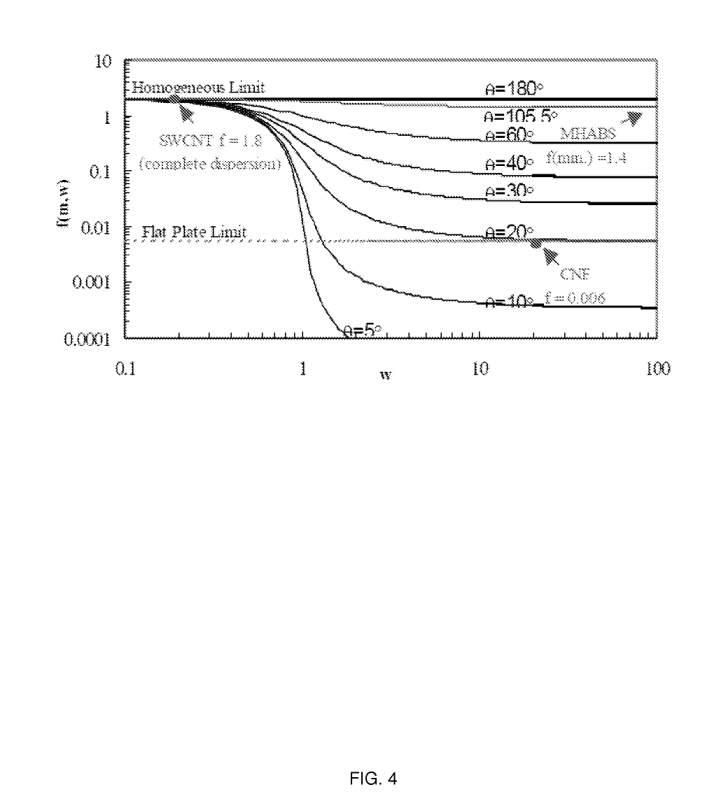

Based on the classical nucleation theory [16, 40], the heterogeneous nucleation rate is expressed as:
Nₕₑₜ=vₕₑₜCₕₑₜexp(−ΔGₕₑₜ*/kT) (3)
where Cₕₑₜ is the concentration of heterogeneous nucleation sites, k is the Boltzmann constant, T is the temperature, Vₕₑₜ is the frequency factor of gas molecules merging with the nucleus, and ΔG*ₕₑₜ is the critical Gibbs free energy to form a critical embryo on the nucleating sites, i.e:

$$\begin{matrix}Δ {G}_{het}^{*} = \frac{Δ {G}_{hom}^{*}}{2} f ( m , w ) & ( 4 ) \\ Δ {G}_{hom}^{*} = \frac{16 {πγ}_{lv}^{3}}{3 Δ {P}^{2}} & ( 5 ) \\ {γ}_{lv} = {{γ}_{lv 0} [ 1 - \frac{T}{{T}_{c}} ]}^{\frac{11}{9}} & ( 6 ) \\ f ( m , w ) = 1 + {( \frac{1 - mw}{g} )}^{3} + {w}^{3} [ 2 - 3 ( \frac{w - m}{g} ) + {( \frac{w - m}{g} )}^{3} ] + 3 {mw}^{2} ( \frac{w - m}{g} - 1 ) & ( 7 ) \\ m = cos Θ & ( 8 ) \\ w = R / {r}^{*} & ( 9 ) \\ {r}^{*} = \frac{2 {γ}_{lv}}{Δ P} & ( 10 ) \\ g = {( 1 + {w}^{2} - 2 mw )}^{\frac{1}{2}} & ( 11 )\end{matrix}$$

where ΔG*ₕₒₘ is the homogeneous Gibbs free energy, which is a function of the polymer-gas surface tension, γ_{Iv} and the pressure difference (ΔP) between that inside the critical nuclei and that around the surrounding liquid. Assuming that the polymer is fully saturated with CO₂ and the partial molar volume of CO₂ in the polymer is zero, ΔP can be taken as the difference between the saturation pressure and the atmospheric pressure. f is the reduction of critical energy due to the inclusion of nucleants, which is a function of the polymer-gas-particle contact angle Θ and the relative curvature w of the nucleant surface to the critical radius of the nucleated phase (Eqs. 7-11). r* is the critical radius. FIG. 4 illustrates how the reduction of critical energy is affected by the nucleants, in terms of surface property (contact angle) and particle geometry (nucleant curvature). Qualitatively, a small contact angle and a large surface curvature offer a higher reduction of critical energy, and consequently an increased nucleation rate.

Under our foaming conditions (T=120° C., P=13.8 MPa), γ_{Iv} was calculated to be −16.43 mJ/m² from Eq. 6 and the known PS-CO₂ surface tension value from the literature, r* is 2.38 nm from Equation 10. Thus the relative radius w is around 21 for individual CNF. With a typical contact angle of 20°, Equation 7 yields a reduction factor f of 0.006 (also marked in FIG. 4), indicating that the energy required for the bubble nucleation (ΔG*ₕₑₜ) on the surfaces of CNFs is only 0.003 (f/2) of that in the homogeneous case (ΔG*ₕₒₘ). In addition, since a complete dispersion of CNFs in the PS matrix was achieved, the actual nucleant density is close to the calculated one. The combination of the low energy barrier and the high nucleant density results in a high nucleation rate and ultimately a high cell density.

In the PS/SWCNTs system, if the SWCNTs are completely dispersed, then the relative radius w is only 0.2 considering that the radius of an individual tube is 0.5 nm. In that case, f is 1.8 and the nucleation energy on any single tube surface would approach the homogeneous limit (as shown in FIG. 4), completely diminishing the benefit of heterogeneous nucleation. However, experimentally, most SWCNTs were observed as spherical agglomerates with an average radius of approximately several dozen nanometers. These agglomerates with much larger radii can serve as lower nucleation energy sites, but the actual nucleant density is much lower than the theoretical value owing to the poor dispersion, leading to the compromised nucleation efficiency.

In the PS/MHABS system, the relatively low nucleation efficiency can be explained first by incomplete particle dispersion. Although exfoliated, stacks of multiple layers are still observable in the polymer domain. A rough estimation from the TEM image of PS/5% MHABS indicates an average stack thickness on the orders of tens of nanometers. Therefore, the actual nucleant density in the PS/5% MHABS system would be reduced by one order from the value shown in Table 1, i.e., from 5.45×10¹³/cm³ to 5.45×I0¹²/cm³. This value, however, is still much higher than the measured cell density (4.02×I0⁸/cm³ suggesting that there must be other reasons accounting for the low nucleation efficiency. On the clay surface, the nucleation energy should approach to the flat plate limit (R→∞) due to the layered structure of the nanoclay. The modified clay surface is more compatible with the PS matrix, and thus the interfacial tension of the PS melt and the clay is expected to be lower than that of PS and CNFs (carbon is well known for its non-wetting property to polymers and a high polymer-particle interfacial tension). Consequently, the contact angle Θ would be higher. This would lead to a significant increase off, or much less reduction of nucleation free energy. Using equilibrium interfacial tension data in the literature [43], the lower limit of Θ is estimated to be 105.5° [44]. This leads to a minimum reduction factor f of 1.4 and a reduction of nucleation free energy by 30%, as illustrated in FIG. 3. Although the PS/5% MHABS system has a much higher number of potential nucleants than both the PS/1% CNFs and the PS/0.1% SWCNTs systems, its nucleation efficiency is greatly compromised by the relative ineffectiveness of the energy reduction. This analysis is in favorable agreement with the previous findings that a weak polymer particle interface is advantageous for bubble nucleation.

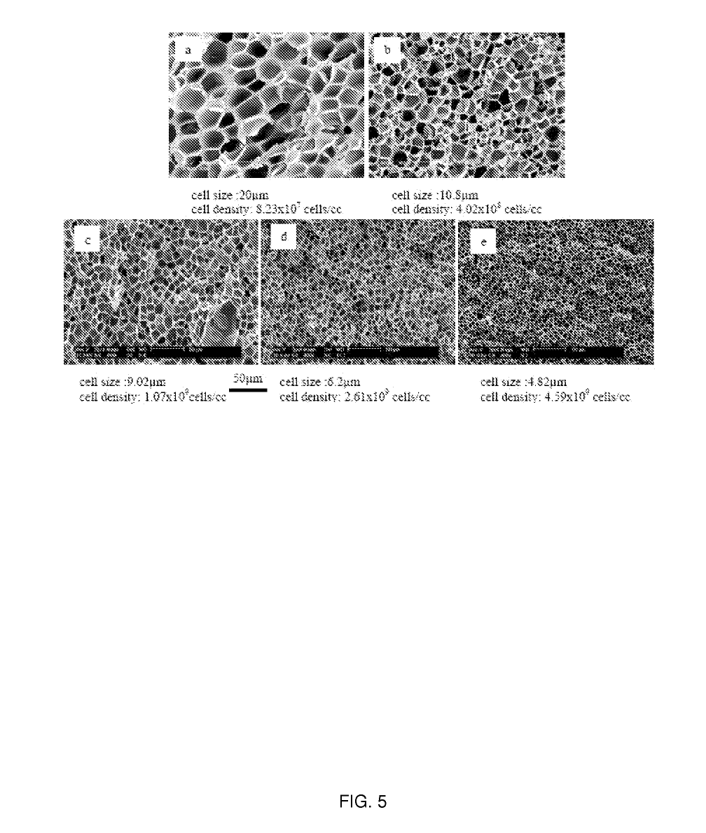

Effects of CNF on cell morphology—A series of PS/CNF nanocomposites was synthesized by the in-situ polymerization process. The content of CNF increased from 0.3, 1.0 to 1.5 wt %. The obtained nanocomposites were foamed under the conditions described before. The cell morphologies are shown in FIG. 5 and compared with pure PS foam and PS/clay nanocomposite foam synthesized under the same foaming conditions.

As shown in FIG. 5, with the addition of CNF, the cell size decreased and the cell density increased. In the presence of only 0.3 wt % CNF, the cell size decreased from 20 μm (pure PS foam) to 9.02 μm (PU#1) and the cell density increased from 8.23×10⁷ cells/cc (pure PS foam) to 1.07×10⁹ cells/cc (PU#1). By increasing the CNF content to 1 wt %, the cell size decreased to 6.2 μm (PU#2) and the cell density increased to 2.61×10⁹ cells/cc (PU#2). Further increasing the CNF content to 1.5 wt % yielded foam with a cell size of 4.82 μm (PU#3) and a cell density of 4.59×10⁹ cells/cc (PU#3). These results imply that CNF serves as a heterogeneous nucleation agent during the foaming process. Therefore, a higher nominal content of CNF in the polymer matrix brings the potential for more nucleating sites.

Compared with nanoclay particles, CNF exhibits a much greater impact on cell morphology than the nanoclay. Sample (b) in FIG. 5 is the PS nanocomposite foam with the addition of 5 wt % MHABS, a surface modified nanoclay leading to an exfoliated PS nanocomposites. However, even with an exfoliated clay dispersion and a higher particle content (5 wt %), the cell size (10.8 μm) was still larger than any of the PS/CNF foams obtained in our study.

Improvements made during the in-situ polymerization process—One problem that occurred during the in-situ polymerization process was that the initial viscosity of the system was not high enough to hold the CNF particles in suspension, thus the partially dispersed CNF may form agglomerates. Two improvements were made to solve this problem. First, we added 10% of PS into the mixture of CNF/styrene system to achieve a higher initial viscosity. We also increased the AIBN content from 0.5 to 0.75 wt % to achieve a higher reaction rate, and thus a higher viscosity increasing rate.

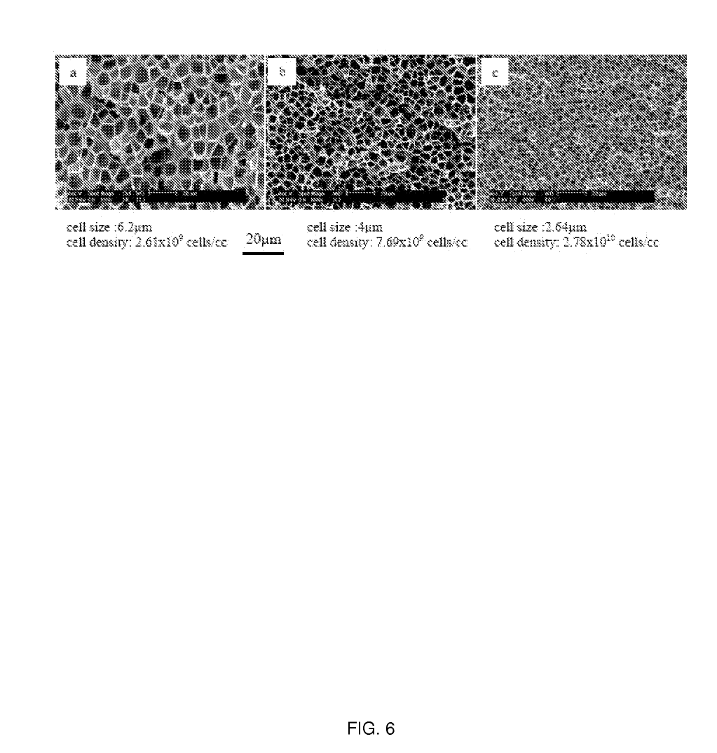

As shown in FIG. 6, with the addition of 10 wt % PS into the polymerization system, the cell size of the obtained PS/CNF nanocomposite foam decreased from 6.2 μm (PU#2) to 4 μm (PU#4) and the cell density increased from 2.91×10⁹ cells/cc (PU#2) to 7.69×10⁹ cells/cc (PU#4). When the initiator content was increased from 0.5 wt % to 0.75 wt %, the cell size further reduced to 2.64 μm (PU#5) and the cell density increased to 2.78×10¹⁰ cells/cc (PU#5), which was about 10 times higher than that of sample PU#2.

Comparing the procedures to synthesize Sample (b) and Sample (c) in FIG. 6, the only difference was the initiator concentration. In the free-radical polymerization, the reaction rate is proportional to the initiator concentration with the order of 0.5, denoted as [I]½. However, the kinetic chain length or the ultimate molecular weight is inversely proportional to [I]½. Therefore, by increasing the initiator concentration, the reaction rate increased as well as the viscosity. However, the molecular weight (MW) of the resulting nanocomposites decreased. These two effects may influence the dispersion of CNF in the polymer matrix. The former ensured a more stable dispersion of CNF in the early stage of polymerization, while the latter offered a better chance for the polymer chains to diffuse into the spaces among the CNF bundles. Both facilitate a molecular level dispersion.

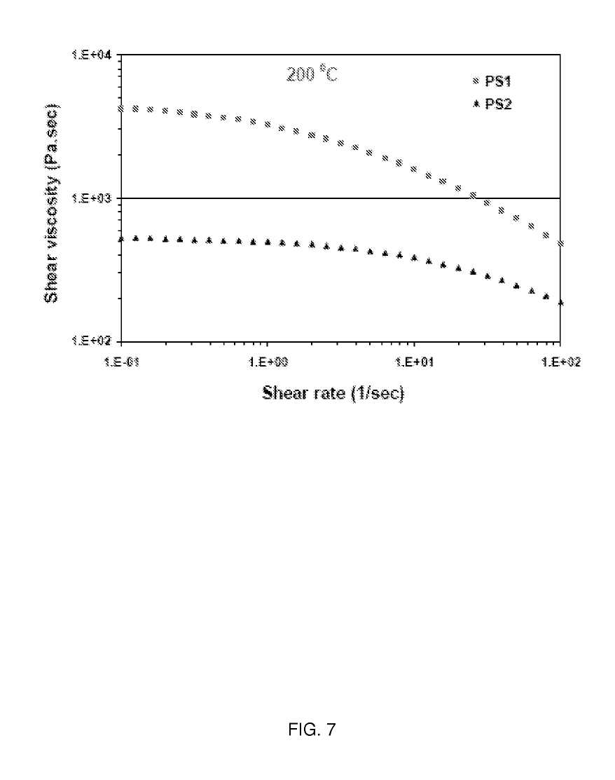

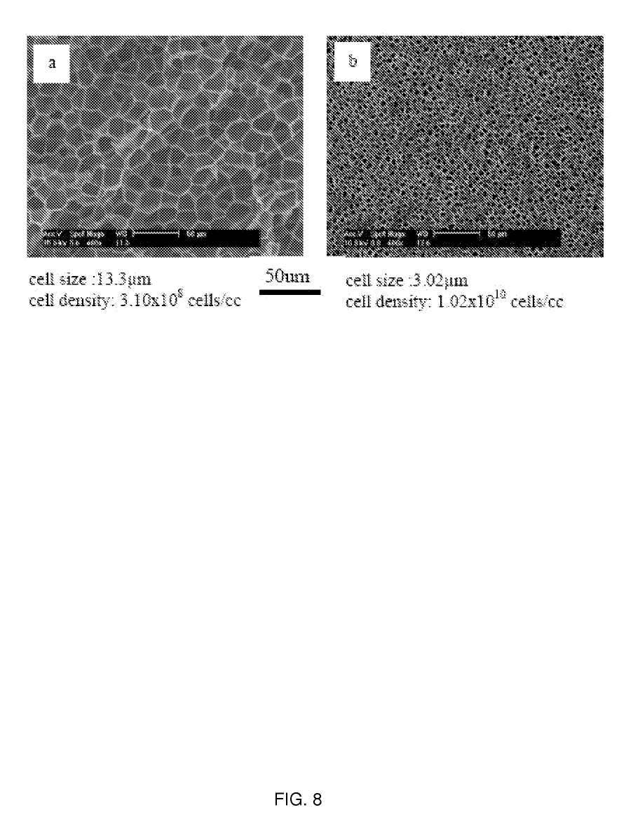

To further study how the polymer molecular weight affects the foam morphology, two types of PS (PS-I and PS-2) with different molecular weights were used to prepare PS/CNF nanocomposites via the melt blending process using a DACA micro compounder. As shown in FIG. 7, the shear viscosity of PS-I is much higher than that of PS-2, which indicates that PS-I has a higher molecular weight than PS-2. The corresponding foam morphologies are shown in FIG. 8. By using a lower MW PS (PS-2), the cell size decreased by almost 4-fold, from 13.3 μm to 3.02 μm, while the cell density increased from 3.10×10⁸ cells/cc to 1.02×10¹⁰ cells/cc. These results support our postulate that the molecular weight of PS has a striking impact on the foam morphology.

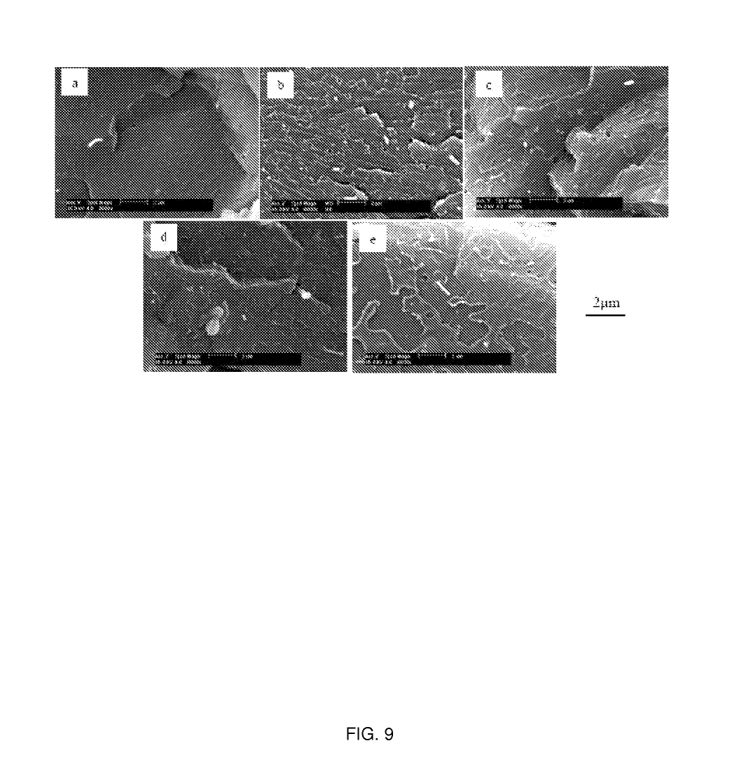

CNF dispersion and interfacial bonding examined by SEM—The dispersion of CNF in the polymer matrix was revealed by SEM on the fracture surface of PS/CNF nanocomposites (FIG. 9). The bright areas in these SEM images are CNF wrapped with PS layers and the holes are locations where CNF was pulled out. As shown in FIG. 9, almost all the protruded CNF and the holes are located separately and there are no CNF agglomerates in the polymer matrix. Apparently, a homogeneous dispersion of CNF was achieved in all of the composites made by the in situ polymerization process.

However, the observed holes and the wide gaps around most nanofibers indicate a poor adhesion and/or wetting between the nanofibers and the matrix. This may reduce the reinforcing performance of CNF. Further research will focus on the surface modification of CNF in order to provide necessary bonding sites and thus to improve the interfacial bonding strength of nanocomposites and foams.

While the invention has been described in connection with what is presently considered to be the most practical and preferred embodiments, it is to be understood that the invention is not to be limited to the disclosed embodiment(s), but on the contrary, is intended to cover various modifications and equivalent arrangements included within the spirit and scope of the appended claims, which are incorporated herein by reference.

What is claimed is:

1. A polymeric nanocomposite produced in accordance with the method comprising the steps of:
providing a mixture comprising: at least one monomer, an initiator, and at least one carbon fiber; and
processing said mixture so as to form a polymeric nanocomposite.

2. The polymeric nanocomposite according to claim 1 wherein said mixture additionally comprises at least one blowing agent, and said method additionally comprises the step of processing said mixture so as to cause the formation of at least one cell, thereby forming a polymeric nanocomposite foam.

3. A polymeric nanocomposite foam, said polymeric nanocomposite foam comprising:
a polymeric portion;
at least one carbon nanofiber, said at least one carbon nanofiber dispersed throughout said polymeric portion; and
a plurality of cells dispersed throughout said polymeric portion.

4. The polymeric nanocomposite foam according to claim 3 wherein said polymeric portion comprises a polymer selected from the group consisting of polystyrene, poly(methyl methacrylate), polypropylene, nylon, polyurethane, elastomers, and mixtures thereof.

5. The polymeric nanocomposite foam according to claim 3 additionally comprising an organophilic clay dispersed throughout said polymeric portion.

6. The polymeric nanocomposite foam according to claim 5 wherein said organophilic clay is dispersed throughout said polymeric portion such that an x-ray diffraction pattern produced from said polymeric nanocomposite foam is substantially devoid of an intercalation peak.

7. The polymeric nanocomposite foam according to claim 5 wherein said organophilic clay is dispersed throughout said polymeric portion such that an x-ray diffraction pattern produced from said polymeric nanocomposite foam contains an intercalation peak.

8. The polymeric nanocomposite foam according to claim 5 wherein said organophilic clay portion comprises:
a smectite clay; and
a compound having the formula: 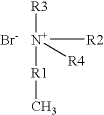
wherein:
R1 is (CH)ₙ wherein n ranges from 6 to 20;
R2 is a chemical structure having a terminal reactive double bond;
R3 is an alkyl group; and
R4 is an alkyl group.

9. The polymeric nanocomposite foam according to claim 8 wherein n is 15, R3 is CH₃, R4 is CH₃, and R2 is:

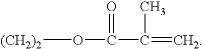

10. The polymeric nanocomposite according to claim 8 wherein said smectite clay is selected from the group consisting of montmorillonite, hectorite, saponite, laponite, florohectorite, and beidellite.

11. The polymeric nanocomposite foam according to claim 3 wherein said polymeric nanocomposite foam has an average cell size less than about 20 microns.

12. The polymeric nanocomposite according to claim 3 wherein said polymeric nanocomposite foam has an average cell size greater than about 15 microns.

13. The polymeric nanocomposite according to claim 3 wherein said polymeric nanocomposite foam has an average cell density greater than about 1×10⁶ cells/cm³.

14. The polymeric nanocomposite according to claim 3 wherein said polymeric nanocomposite foam has an average cell density greater than about 1×10⁹ cells/cm³.

15. The polymeric nanocomposite according to claim 3 wherein said polymeric nanocomposite foam is closed cell foam.

16. The polymeric nanocomposite according to claim 3 wherein said polymeric nanocomposite foam is open cell foam.
